(19) United States
(12) Patent Application Publication
(10) Pub. No.: US 2014/0144391 A1
(43) Pub. Date: May 29, 2014

(54) Animal Perching Deterrent Means

(71) Applicant: David Lee Ashworth, Lancaster, PA (US)

(72) Inventor: David Lee Ashworth, Lancaster, PA (US)

(21) Appl. No.: 13/687,014

(22) Filed: Nov. 28, 2012

(51) Int. Cl. A01M 29/32

(52) U.S. Cl. CPC A01M 29/32
USPC 119/713

(57) ABSTRACT

An animal perch deterrent device comprise a central axis line which has a plurality of radially extending spokes or spikes integrated with and attached to the line at their base that run along the length of central axis line at equidistantly placed intervals and whose proximal end are affixed thereto so that each spike radiates out and away from the central axis line. The device further comprises a first attachment means for securing the distal end of the central axis line to the stern of a boat and a second attachment means on the proximal end of the axis line that is secured to the lower or base portion of the mast. The outwardly and radially extending spikes are comprised of cable ties integrated with and attached to the line at their base and run along the length of central axis line at approximately equidistantly placed intervals. When the device is employed, the central axis line from which the radially extending spikes extend runs parallel to and slightly above the boom of the sailboat when the sail of the boom is furled.

### CROSS-REFERENCE TO RELATED APPLICATIONS

This application claims the benefit of priority of U.S. Provisional Appln. No. 61/567,309 filed on Dec. 6, 2011.

### FIELD OF THE INVENTION

The invention relates generally to animal deterrent devices and means to keep mammals and birds away from places or things that they otherwise might do damage to either by physical destruction or through urination, defecation, mating or nesting. More particularly, the present invention relates to avian perching or roosting deterrents useful in the marine and boating industries.

### BACKGROUND OF THE INVENTION

The present invention generally relates to bird deterrent devices and efforts to reduce messy bird dropping on sailboats and powerboats. For centuries, birds (particularly seagulls and ospreys) have flocked to any horizontal surface on a boat. It is not uncommon to see vessels of all kinds covered with roosting birds and, as a result, their messy droppings. Sailboats and powerboats on moorings are particularly vulnerable as they are out in open water; however, boats in marinas do not escape this avian attack. Wherever you find boats, you will find birds looking for a place to land. Sailboat booms and biminis as well as powerboat fly-bridges and swim platforms make ideal perches and birds are often seen lining up along these nautical landing zones. Once a vessel becomes a roosting place, the problem only escalates as birds are attracted to locations where other birds have left their droppings.

Bird excrement or droppings can quickly cover an entire vessel. Once dry, droppings are extremely difficult and time consuming to remove. They can cause costly damage or stains to fiberglass and canvas. Expensive cleaners, many of which contain chemicals which are hazardous to the environment and may also damage and stain fiberglass decks and hulls, are required to remove caked on droppings. Within an hour, a flock of gulls or birds can create an exhausting and frustrating boat cleaning nightmare. No boat owner wants to spend hours cleaning up the droppings and feces of birds and/or other animals for that matter.

The best, most efficient and cost effective method of addressing animal or bird droppings is to prevent them from occurring in the first place. If animals such as squirrels, chipmunks and birds can't roost in a particular location, then the area below that potential roosting spot will not be covered with an over-abundance of droppings. In the past, efforts to deter birds from landing on boats and/or roosting on the sails, lines and moorings thereof have included rotating apparatuses or devices which simulate avian predators. These have proven to be generally ineffective, costly and difficult to mount on boats. Metal or plastic strips with spikes have been used for buildings, fences or fixed structures. However, the lack of flexibility, the segmented design, the difficulty in mounting and the inability to coil and store the strips easily have limited the use of such strips on boats. Chemical sprays or repellants used on other animals are ineffective on birds, particularly on vessels exposed to weather and conditions which may wash them away. Noise making devices such as cannons to scare away birds are expensive, offensive to neighbors and contribute to noise pollution.

U.S. Pat. No. 6,918,214 to Sabine et. al. discloses a device for deterring birds from perching on undesired perch locations. The device includes various embodiments which are constructed of wires forming arcs and/or wires that are parallel to and spaced above an object such as a light fixture to be protected. The wires are sufficiently flexible and have a small enough diameter to prevent the birds from getting a secure footing thereon but are sufficiently stiff to keep the birds from reaching the object.

U.S. Pat. No. 7,581,359 to Bukeavich teaches and claims a decorative bird perching deterrent device for spaces between building eaves and downspouts is a substantially right-triangle structure of a preselected material with at least 50 percent of the area bounded by the sides of the right triangle structure filled with the preselected material in a decorative fashion. Various ways of attaching to the downspout or the building are provided near at least one edge of the right-triangle structure.

U.S. Pat. No. 7,581,359 to Donoho discloses a bird deterrent device which has a base and at least one branched spike extending from the base. The branching can occur anywhere along the spike, and a single branch point can give rise to multiple branches. Spikes can have multiple branches. The various branches can be of any suitable length(s), and can be oriented in any suitable direction(s).

### BRIEF DESCRIPTION OF THE DRAWINGS

FIG. 1 is a side-view of one embodiment of the animal perching deterrent device while in operational use placed above the boom of a sailboat.

FIG. 2 is an overall shortened perspective of the entire animal perching deterrent device of the present invention

FIG. 3 is a side view of the distal or aft (stern) end of a sailboat boom showing the respective elements of the animal perching deterrent device secured at the distal end of the boom.

FIG. 4 is a dissected and segmented partial top perspective view of the animal perching deterrent device showing the respective end elements of the cable and ties secured to the mast above the boom at the proximal end thereof.

FIG. 5 is a partial cross-sectional view of a segment of the animal perching deterrent device showing the respective elements and their structural interrelationships

FIG. 6 is a partial cross-sectional view of a segment of second embodiment of the animal perching deterrent device of the present invention.

FIG. 7 is an angled view of an isolated spike/clip showing the pointed spike and circular bore portions.

### SUMMARY OF THE INVENTION

The present invention comprises an animal perch deterrent device consisting of a central axis line which has a plurality of radially extending flanges or spikes integrated within and attached to the line at their base that run along the length of central axis line at equidistantly placed intervals and whose proximal end are affixed thereto so that each flange radiates out from the central axis line. The central axis line further comprises two attachment means, one at the proximal end for securing the line to a sailboat mast and at the distal end of the line for attaching and securing the line in the proximity of the stern above the boom of the sail

### DETAILED DESCRIPTION OF THE INVENTION

The present invention comprises an animal perch deterrent device comprised of a central axis line which has a plurality of radially extending spikes or spikes integrated with and attached to the line at their base that run along the length of central axis line at equidistantly placed intervals and whose proximal end are affixed thereto so that each spike radiates out from the central axis line. The central axis line preferably consists of a measured length of flexible wire line or polyester or nylon line/rope with 8″-12″ roost arresting spikes (cable ties) woven into the line at approximately ½″-1″ intervals with attachment/securement means at both ends thereof. The attachment means may comprise an eye splice and an elastic shock cord on a proximal end that is attachable to the mast of a sailboat and a stainless steel hook on the distal end to attach to the stern of the boat or distal end of the boom. In one embodiment, the shock cord may be threaded through the eye splice on one end of the line that is attached to the location intended to be protected from birds. The stainless steel hook is connected to the other end of the line by a knot. The line is pulled tight and connected to any location to which the stainless steel hook can be attached. The cable ties woven into the line/rope act as spikes or barbs which make it difficult for birds to land, perch or roost on the central axis line. The amount of line/rope used is determined by measuring the length of the area intended to be protected. Embodiments of the present invention provide bird deterrent device apparatuses to reduce the ability of birds to land or roost upon the location no where the apparatus is installed thereby reducing bird dropping on adjacent surfaces.

In some embodiments, the invention can be mounted along the length of a sailboat's sail boom with the shock cord wrapped around the mast on the proximal end and the stainless steel hook attached to the end of the boom on the other distal end. The length of the boom would determine the length of line/rope used. The shock cord allows the line to flex thereby making it difficult for birds to land, even if the spikes fail to act as a deterrent device. The device is mounted approximately 5-10 inches above the sail boom (with the sail furled/folded) to prevent birds from roosting.

In some embodiments the invention can be mounted along the ridge of a sailboat or powerboat's bimini, dodger, fly-bridge, awnings, swim platforms and/or lifelines to no deter birds from landing. With the shock cord and stainless steel hook, the invention is designed to be mounted quickly and easily along the ridge of any surface that has attachment points. The invention may be used without the shock cord and stainless steel hook in some embodiments. Unlike other stiff, inflexible spike-type devices, the flexibility of the line and spikes of this invention provide for easy coiling and storage with us no danger to birds or crew.

The animal perch deterrent device is suitable for use in any number of applications and when properly secured in the appropriate fashion may be used to keep four-legged mammals out of certain areas or may be used to prevent birds and other winged animals from alighting or roosting on particular areas. Preferably, the animal deterrent is comprised of a central axis line which has a plurality of radially-extending spikes or spikes integrated with and attached to the line at their base. These radially extending protrusions run along the length of central axis line at equidistantly placed intervals and their proximal end is affixed thereto so that each spike radiates out from the central axis line in a 360° arc. The deterrent device further comprises a stainless steel hook which is attached at the distal end of the central axis line for securing the distal end of the line to one end, preferably the stern of a boat or the far end of the boom. The deterrent device also comprises a spring engaging wrap device on the proximal end of the central axis line that is secured to the other proximal end of the line, preferably the lower or base of the mast. The radially extending spikes are preferably comprised of cable ties integrated with and attached to the line at their base along the length of central axis line at approximately ½-1 inch equidistantly placed intervals. The proximal end of the animal perch deterrent device is then also preferably secured to the mast of a sailboat and the distal end is secured to a point above the stern so that the central axis line from which radially extending spikes extend runs parallel to and slightly above the boom of the sailboat when the sail of the boom is furled and wrapped within the sailcover.

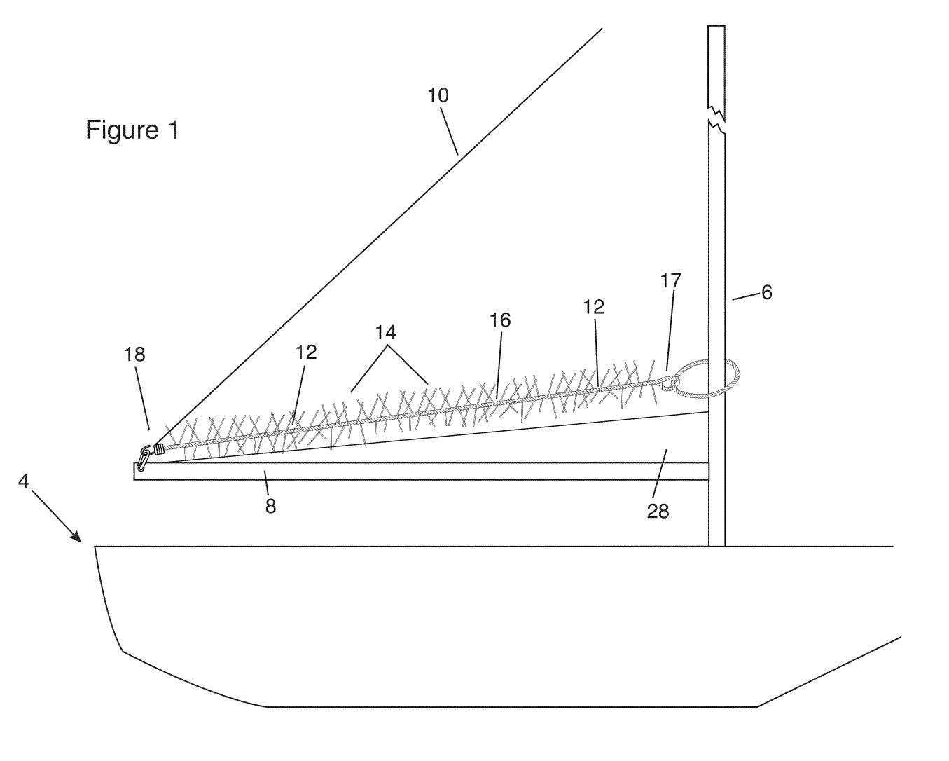

Referring now to FIG. 1, one embodiment of the animal perching deterrent device of the present invention (2) can be seen as employed in operational use on a sailboat (4) when the boat itself is not in use and is moored at the dock in a marina or harbor. The perspective shown is a partial side view of the sailboat showing the mast (6), the boom (8) and the back stay line or wire (10). The perching deterrent device (2) is employed attached to the boat secured and in place above and substantially parallel to the boom (8) of the sailboat. The device is comprised of a central axis line (12) which has a plurality of cable ties (14) integrated with and attached to the line at their base (16) along the length of central axis line (12) at approximately ½-1 inch equidistantly placed intervals. The central line can be made from any durable material but most preferably a polyester line (¼″) which can be manufactured to any desired length according to the length of the boat, boom or length of area to be protected.

The proximal (17) and distal (18) ends of the central axis line (12) are affixed to the mast (6) and boom (8) or other point on the stern (not shown) and runs along the top-side of the boom so that each spike radiates out from the central axis line in a substantially 360° arc. Other suitable places to secure the device at either end such as the mast or stern are possible but the base of the mast and the boom bail are preferred.

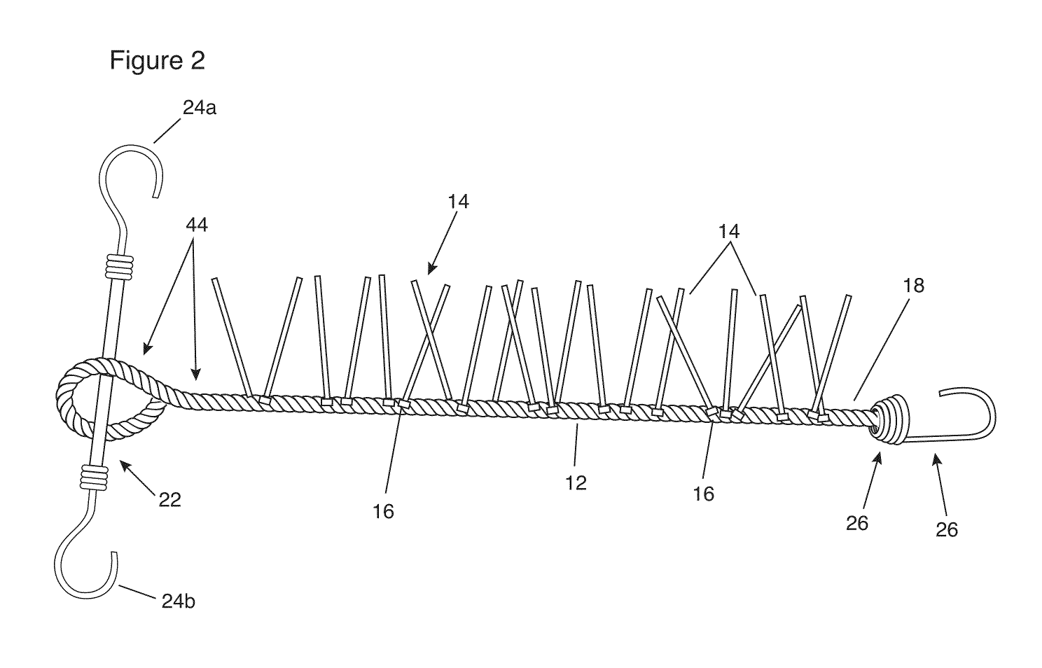

Referring now to FIG. 2, the preferred embodiment of the animal perching deterrent device of the present invention is again shown in toto, isolated from it's operational employment in conjunction with a sailboat. The central axis line (12) is shown with the plurality of radially-extending cable ties, spikes or spikes (14) integrated with and attached to the line at their base (16). These radially extending protrusions run along the length of central axis line (12) at equidistantly placed intervals along the topside and above the boom (8) and when placed therein radiate in a V-like arc up and out so that any seagull, pigeon or other avian species will not be able to alight and perch thereon as they are very prone to do. Since they cannot perch or roost thereon they will be unable to defecate making a considerable mess when they gather in large numbers as they are apt to do.

The proximal (17) and distal (18) ends of the central axis line end are affixed to the mast and stern respectively (not shown) and runs along the top-side of the boom so that each spike radiates out from the central axis line in a substantially 360° arc. The deterrent device further comprises a spring engaging wrap device or elastic shock cord (22) with a hook on each end (24a,b) which is attached at the proximal end of the central axis line (12) for securing the proximal end of the line to the mast (6) of a boat. The deterrent device also comprises a stainless steel hook (26) on the distal end of the central axis line that secures the distal end to the stern of the boat or end of the boom (8). The radially extending spikes (14) are preferably comprised of cable ties integrated with and attached to the line at their base along the length of a central axis line at approximately ½-1 inch equidistantly placed intervals. The interval distance between the spikes along the cable is variable and depending upon the severity or degree in terms of numbers of perching birds that will rest on the area in question, the space may be from one-half inch (½″) to a foot between spikes. The proximal end of the animal perch deterrent device is then also preferably secured to the mast of a sailboat and the distal end is secured to a point above the stern of the boat or end of the boom (8) so that the central axis line from which the radially-extending spikes extend runs parallel to and slightly above the boom of the sailboat when the sail of the boom is furled and wrapped within the sail cover (28).

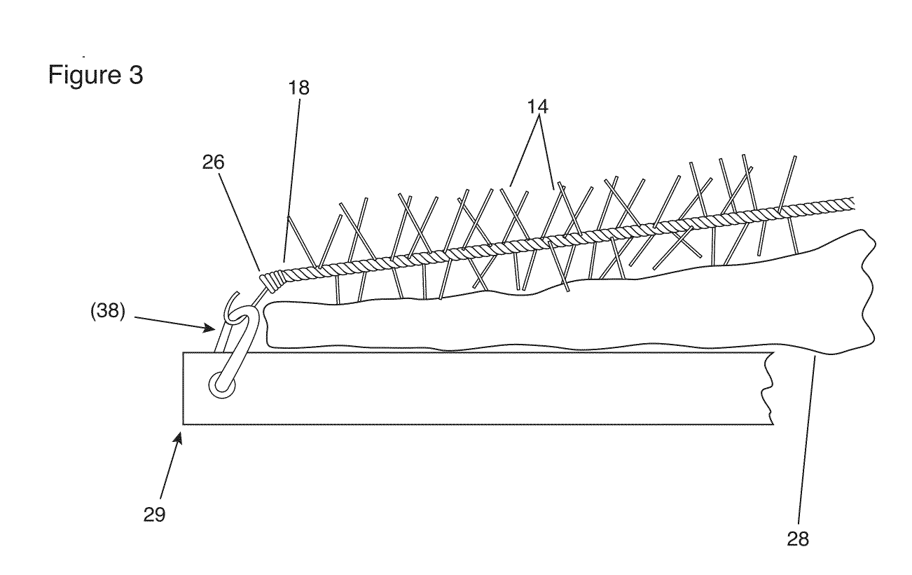

Referring now to FIG. 3, the distal or stern end of the boom (29) is shown from a side perspective with the animal perching deterrent device of the present invention secured thereto. In one embodiment of the invention as shown here, the distal end of the device (18) is comprised of a hook (26) connected to the central cable axis line (12). The line may be secured by any plausible means but preferably is a hook (30) that can be engaged with the boom bail of the boat. The plurality of radially extending spikes (14) can be seen running contiguously along the central core line from the middle of the core line to the distal end (18). The device is secured to the mast at the proximal end with a spring engaging wrap device or elastic shock cord (22) (not shown).

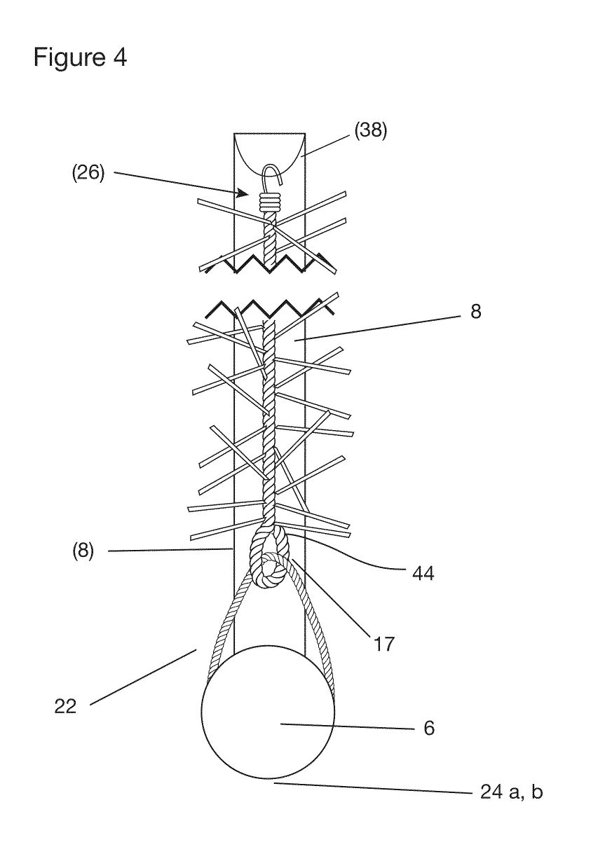

Referring now to FIG. 4, the main functional components of the animal perching deterrent device of the present invention are shown with the main body of the central axis cut away to better depict the distal (18) and proximal (17) attachment means as used in it's operational employment in conjunction with a sailboat boom and mast. The distal end (18) which attaches to the stern of the boat or the boom bail (38) at the far end of the boom in this embodiment is comprised of a stainless steel hook (26) that is integrally connected to the central axis line (12) by any means known by those skilled in the art. The attachment means at the proximal end of the central axis line (17) here consists of a spliced eyelet (44) through which a spring engaging wrap device or elastic shock cord (22) is looped for securing the perching deterrent device of the present invention to the mast (6). The distal and proximal attachment means (18,17) may be comprised of a variety of different hooks, flanges, ties, clips, cords, etc as known in the art and the present invention is not to be limited to those specifically disclosed and envisioned herein however.

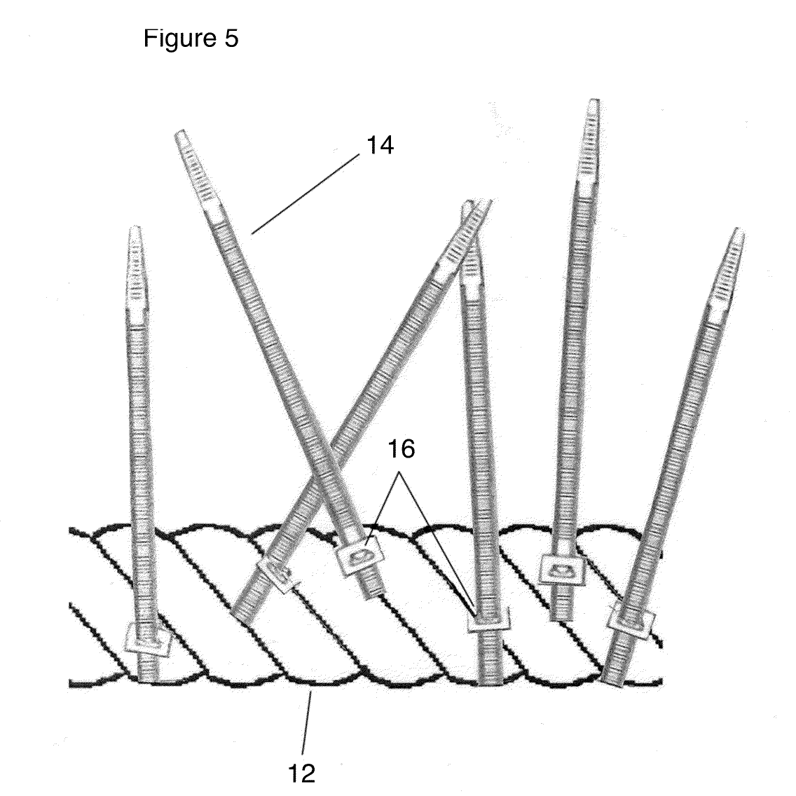

Referring now to FIG. 5, a close up, partial cross-sectional view of a segment of the animal perching deterrent device shows the respective elements and their structural interrelationships. The central axis line (12) has a plurality of cable tie spikes (14) integrated with and attached to the line at their base (16) along the length of central axis line (12) at approximately ½-1 inch equidistantly placed intervals. These are generally eight (8) to twelve (12) inches long and are spaced equidistantly along the entire length of the axis line (12) which is secured at the distal end to the stern (14) of the boat and at the other end to the bow tip (of a power boat not shown) or to the boom (8). When the perching deterrent device is employed with a sailboat, it is secured to the mast at the proximal end by an attachment device such as a UV resistant bungee cord, spring engaging wrap device or elastic shock cord (22) which is threaded through an eye splice (44). The distal end of the central axis line (18) is comprised of a stainless steel hook (26) which is attached at the end of the line by a knot or other means and used to attach the line to the desired location on the stern of the boat or the end of the boom (29). The eye splice (44) is spliced at the opposite end of line from the hook (26).

When the perching deterrent device is employed with a sailboat, it is secured to the mast at the proximal end by an attachment device such as a UV resistant bungee cord, spring engaging wrap device or elastic shock cord (22) which is threaded through an eye splice (44). The distal end of the central axis line (18) is comprised of a stainless steel hook (26) which is attached at the end of the line by a knot or other means and used to attach the line to the desired location on the stern of the boat or the end of the boom (29). The eye splice (44) is spliced at the opposite end of line from the hook (26).

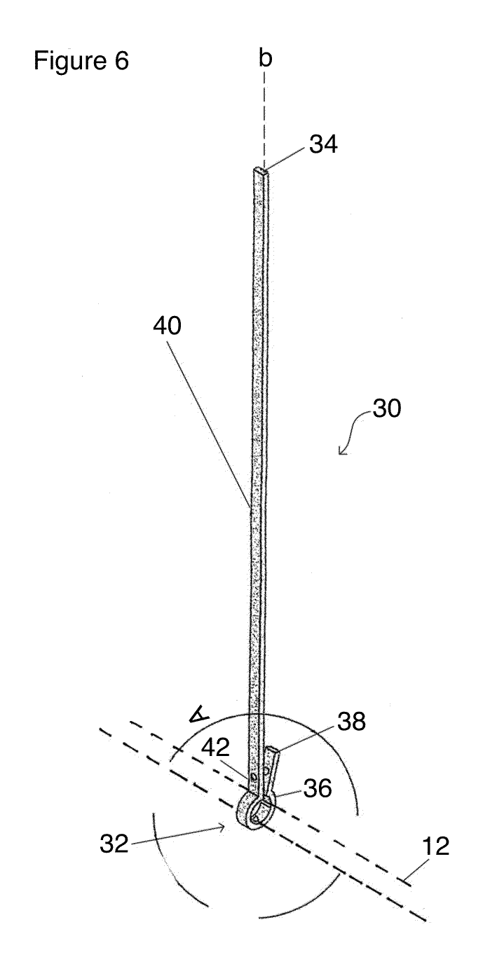

Referring now to FIG. 6, the cable spike (14) as shown in FIGS. 1-5 is depicted as a single unit (30) with a proximal end (32) and a distal end (34). This spike unit (30), like all the previously described embodiments of the invention, is preferably a one-piece, molded flexible unit comprising polyethylene or polypropylene or other similar plastic material that is inexpensive to manufacture and is remove-ably attachable to the central axis cable (12). This way, they are easy to replace and snap onto the cable line if damaged. In FIG. 6, the central axis cable line depicted in FIGS. 1-5 as (12) is not shown and here is represented as a dotted line (12) that runs perpendicular to the axis line (b) of the cable spike (30) Here the entire spike unit is pre-form molded with an attachment means (36) formed as a part of and comprising the proximal end (32) of the unit (30). As can be seen from FIG. 6, the attachment means is formed as a substantially circular, open clip (36) with a flexible smaller tab or minor flange (38) derived and extending there from. Here then, the element is comprised of only one major spike (40), the major spike emanating from the circular portion at the proximal end (36). This represents one of a plurality of spikes or cable ties (14) that can be snapped onto and attached along the length of central axis line (12) at approximately ½-1 inch equidistantly placed intervals as discussed earlier. The distance between the spikes and hence the number used is variable and may be tailored to the users' need

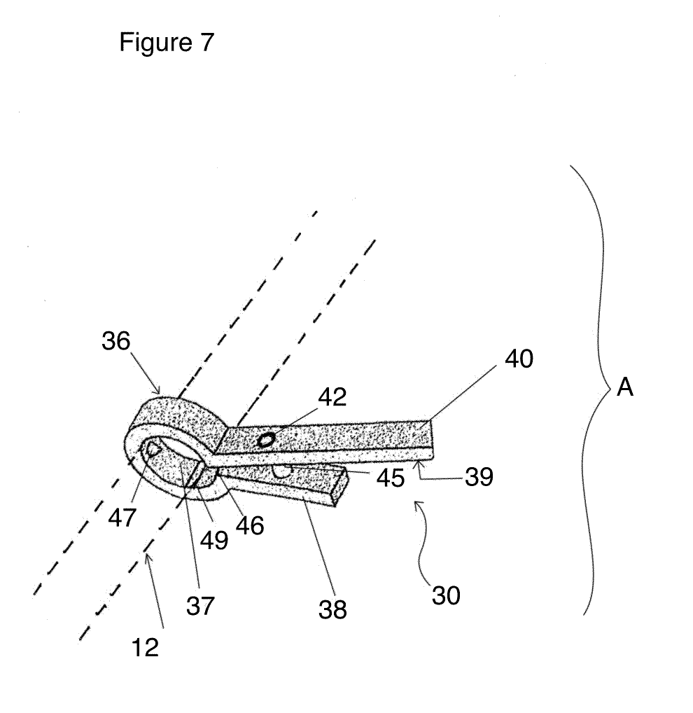

The clip (36) formed at the proximal end (32) of the deterrent element is shown enlarged and in greater detail in FIG. 7 (A). There it can be seen that the smaller tab or flange (38) that extends from the substantially circular clip portion (36) is essentially rectangular in shape and extends at an angle from the planar surface of the major portion of the spike (40). Whereas the actual length of the spike (40) or that of the smaller tab flange (38) should not be regarded as a limiting feature of the invention, as with all the other previously described embodiments of the invention, the spike portion (40) is generally eight (8) to twelve (12) inches long from the proximal (32) to the distal end (34). The flexible, smaller tab or flange (38) can conceivably be of any length but is preferably no more than two (2) inches long and for aesthetic purposes and ease of use is about one (1) inch in length.

The shorter flange (38) extends at an angle there from and is flexibly resilient. The proximal end (42) of the flange (38) creates a gap between the smaller tab (38) and the longer spike flange (40) that forms a slot (46) through which the axis cable line can be inserted into the eyelet (37) of the clip (36) of the unit (30). The angle itself may vary from 15 to 90 degrees and is preferably from about 20° to about 50° and this is a variable depending upon how tight a lock or grip the user wants the spike to maintain on the hanger axis cable line (12). The smaller the angle, the tighter the lock or grip of the clip (36) on the cable line (12). As shown earlier in FIGS. 2-5, the overall view of the animal perching deterrent device shows the respective elements and their structural interrelationships comprising the present invention. The central axis line (12) has a plurality of cable ties (14, 30) integrated with and attached to the line at their base (16, 32) along the length of central axis line (12) at approximately ½-1 inch equidistantly placed intervals along the entire length of the axis line which is secured at the distal end to the stern (14) of the boat and at the other end to the bow tip (of a power boat not shown) or to the boom (8) of a sail.

As also can be seen in FIG. 7, disposed within the major spike portion (40) in juxtaposition with the circular portion of the clip (36) is a hole or bore (42) which may or may not pass through the entire thickness of the major flange/spike element (40) Preferably, the bore passes throughout and is positioned to accept the insertion of a small post or peg (45) that sticks up and is derived from the planar surface of the second, smaller tab (38). When in use, the main cable line (12) is pressed through the gap or groove (46) into the eyelet (37) comprising the proximal end of the deterrent spike unit (30). The smaller tab flange (38) is pressed inward and flush against the lower planer surface of the larger flange spike so the peg or post (45) enters and is secured within the hole (42) thereby locking the deterrent unit onto the central axis line as shown in FIGS. 1 and 2. In other words, once the line is place inside the ring, the plastic tab (38) and the longer spike (40) are squeezed together so that the clip (36) it fits tightly around the line. The peg (45) fits into hole (42) and holds the entire spike unit (30) tightly onto and around the line (12).

Also shown in FIG. 7, disposed within the inner surface or rim of the circular clip portion (36) is a small protrusion or pointed nub (47) which is pushed into the surface of the cable line (12) when the smaller tab (38) is locked in place, flush against the lower surface (39, not shown) of the major spike (40). This secures the inner rim of the clip (49) onto the peripheral surface of the central cable line and prevents each spike unit (30) of the deterrent device (2) from slipping or moving thereon and assists in keeping the plurality of the spikes equidistantly spaced on the cable.

In toto, then, the animal perch deterrent device of the present invention comprises a central axis cable line which has a plurality of radially-extending spike elements (14, 40) attached to the line at their base that run along the length of central axis line at equidistantly placed intervals and whose proximal ends are affixed thereto so that each spike radiates out from the central axis cable line (12). The spike element comprises at least one major flexible flange (40) with an attachment means formed as a part of the proximal end of the flange portion of the spike element for attaching the spike flange to the central cable axis line. The attachment means may optionally comprise a ring clip which has a second flexible smaller tab or minor flange derived and extending from the outer radius of the circular body portion of the ring clip.

The ring clip is partially opened due to the presence of a small gap in the circumference of the circular body portion of the ring clip and the clip attaches to the central cable axis line by pushing the cable line through the gap so that the inner circumference of the circular body portion of the ring clip surrounds the central axis cable line about the outer circumference of the cable line. The ring clip may further comprise a second flexible smaller tab or minor flange derived and extending from the outer circumference of the ring clip at the edge of said gap. The second flexible smaller tab may also optionally further comprise a centrally located post or protrusion emanating upwardly from the planar surface of the tab that is in alignment with a centrally located hole or bore centrally disposed in the larger portion of the spike element. When both the tab and flange are pressed together so that the upper planar surface of the tab and the lower under surface of the larger flange are touching, the post of the tab intersects and enters the hole and is secured therein, locking the clip onto the central axis cable. A small protrusion on the inner surface of the ring clip further maintains the flange position on the cable. The flange or spike portions of the unit are flexible yet rigid enough to stand up straight and outward from the cable line.

The background and detailed description as well as the drawings included herein are intended to be illustrative in nature and are not intended to limit the scope, applicability, or configuration of the invention in any way. Rather, these are intended to be practical illustrations for implementing the various possible embodiments of the present invention. The actual construction, materials, dimensions, and manufacturing processes useful in assembly of the actual components are known to those of ordinary skill in the art who will recognize that many of the examples provided have suitable alternatives that can be utilized and are contemplated herein. Therefore, it is to be recognized that the description and drawings are for illustrative purposes only and should not be interpreted as limiting the spirit and scope of the invention as recited in the claims that follow.

What is claimed is:

1. An animal perch deterrent device comprised of a central axis line which has a plurality of radially extending spokes or spikes integrated with or attached to the line at their base that run along the length of central axis line at equidistantly placed intervals and whose proximal end are affixed thereto so that each spike radiates out from the central axis line.

2. The animal perch deterrent device of claim 1 wherein said central axis line further comprises a first attachment means for securing the distal end of the line to the stern of a sail boat.

3. The animal perch deterrent device of claim 2 further comprising a second attachment means on the proximal end of the line that is secured to the lower or base portion of the sail boats' mast.

4. The animal perch deterrent device of claim 3 wherein the radially-extending spikes are comprised of cable ties integrated with and attached to the line at their base along the length of central axis line (6) at approximately ½-1 inch equidistantly placed intervals up to about twelve (12) inch intervals.

5. The animal perch deterrent device of claim 4 wherein the proximal end is secured to the mast of a sailboat and the distal end is secured to a point above the stern so that the central axis line from which the radially extending spikes extend runs parallel to and slightly above the boom of the sailboat when the sail of the boom is furled

6. The animal perch deterrent device of claim 5 wherein said first attachment means for securing the distal end of the central axis line to the stern of a boat. comprises a hook, clamp or flexible metal twist tie.

7. The animal perch deterrent device of claim 5 wherein said second attachment means for securing the proximal end of the central axis line to the lower or base portion of the mast comprises an eye splice and an elastic shock cord.

8. An animal perch deterrent device comprised of a central axis cable line which has a plurality of radially-extending spike elements attached to the line at their base that run along the length of central axis line at equidistantly placed intervals and whose proximal end are affixed thereto so that each spike radiates out from the central axis cable line.

9. The animal perch deterrent device of claim 8 wherein the spike element comprises at least one major flexible flange with an attachment means formed as a part thereof at the proximal end of the flange portion of the spike element.

10. The device of claim 9 wherein the spike element further comprises an attachment means at the proximal end thereof that is formed as a substantially circular, partially open ring clip for attaching to the central cable axis line.

11. The device of claim 10 wherein the ring clip has a second flexible smaller tab or minor flange derived and extending from the outer radius of the circular body portion of the ring clip.

12. The device of claim 11 wherein the ring clip is partially opened due to the presence of a small gap in the circumference of the circular body portion of the ring clip.

13. The device of claim 12 wherein the ring clip further comprises a second flexible smaller tab or minor flange derived and extending from the outer circumference of the ring clip at the edge of said gap.

14. The device of claim 13 wherein said ring clip attaches to the central cable axis line by pushing the line through the gap so that the inner circumference of the circular body portion of the ring clip surrounds the central axis cable line.

15. The device of claim 14 wherein said second flexible smaller tab further comprises a centrally located post or protrusion emanating upwardly from the planar surface of the tab.

16. The device of claim 15 wherein the flange portion of the spike element. further comprises a centrally located hole or bore that above and aligned with said post or protrusion emanating upwardly from the planar surface of the smaller tab.

17. The device of claim 16 wherein the ring clip further comprises a second small protrusion or post extending from the inner side walls of the ring clip towards the center of the space formed by the clip.

18. The device of claim 17 wherein the protrusion or post extending from the inner side walls of the ring clip further comprises a second small protrusion or post extending from the inner circumference of the ring clip towards the central axis of the clip and intersects.

19. The device of claim 18 wherein the protrusion or post extending from the inner side walls of the ring clip intersects and snares the side walls of the central axis cable when the cable is inserted therein and impedes any movement of the ring clip with respect to the cable.

20. The device of claim 19 wherein the spike element comprises a flexible flange with an attachment means formed as a part thereof at the proximal end of the spike element that is formed as a substantially circular, open ring clip for attaching to the central cable axis line with a flexible smaller tab or minor flange derived and extending from the outer radius of the circular body portion of the ring clip.
